(19) United States
(12) Patent Application Publication
(10) Pub. No.: US 2023/0337854 A1
(43) Pub. Date: Oct. 26, 2023

(54) BEVERAGE PREPARATION MACHINE WITH MACHINE HOUSING AND DETACHABLE LIQUID TANK

(71) Applicant: SOCIETE DES PRODUITS NESTLE S.A., Vevey (CH)

(72) Inventors: ALEXANDRE KOLLEP, Lutry (CH); DIDIER VUAGNIAUX, Gimel (CH)

(21) Appl. No.: 18/006,907

(22) PCT Filed: Jul. 29, 2021
(86) PCT No.: PCT/EP2021/071284

§ 371 Date: Jan. 26, 2023

(30) Foreign Application Priority Data
Jul. 29, 2020 (EP) 20188293.3

(51) Int. Cl. A47J 31/46; A47J 31/44

(52) U.S. Cl. CPC A47J 31/465; A47J 31/4403; A47J 31/468

(57) ABSTRACT

The invention concerns a beverage preparation machine (1), which is, in particular, more compact and easier to be refilled with liquid such as water. The beverage preparation machine (1) comprises: a machine housing (2) for enclosing machine functional elements, which machine functional elements (6) include at least a beverage brewing chamber, and a liquid tank (7) detachably arranged to move along a movement axis in order to be, in an inserted position, functionally inserted entirely within the machine housing (2) such that liquid can be delivered from the liquid tank (7) to the beverage brewing chamber for mixing with a beverage ingredient contained therein, and therefore for preparing a beverage. The machine housing (2) comprises a first opening (51) and a second opening (41), which are located on opposite wall portions (4, 5) of the machine housing (2), and wherein, when the liquid tank (7) is in the inserted position, the first opening (51) is arranged to expose a part of the liquid tank (7) such that pushing said exposed part of the liquid tank (7) moves the liquid tank (7) along the movement axis and out of the inserted position trough said second opening (41).

### FIELD OF THE INVENTION

The present invention concerns a beverage preparation machine for preparing a beverage, comprising a machine housing and a detachable liquid tank.

### BACKGROUND OF THE INVENTION

A beverage preparation machine is used for preparing a beverage such as a coffee. The beverage preparation machine comprises a machine housing and a detachably arranged liquid tank, which is, for example, a water tank. The liquid tank is used for refilling the beverage preparation machine with a liquid, e.g. water, required for preparing the beverage. That is, the liquid tank can be detached and, in a thus detached state of the liquid tank, refilled, such as with liquid from an external liquid source, e.g. water from a tap. Subsequently, the liquid tank is again attached to the beverage preparation machine in order to prepare a specific number of beverages, which number corresponds to the liquid contained in the liquid tank.

In the attached position of the liquid tank, the liquid tank is placed outside of the machine housing, such as positioned at or on an outer wall of the machine housing. This results in that the beverage preparation machine requires much space.

Further, the liquid tank needs to be handled along different directions, in particular with respect to the horizontal axis and the vertical axis, in order to move the liquid tank at least into the attached position. These axes may correspond to the width, depth, and height of the machine, respectively. However, handling the liquid tank along different direction is not very convenient. In addition, the liquid tank comprises dedicated handling structures, such as a handle, in order to move the liquid tank securely into the attached position. Providing such handling structures on the liquid tank however also results in a complex and, thus, cost-intensive design of the beverage preparation machine.

Therefore, it is an object of the present invention to provide a beverage preparation machine, which overcomes the aforementioned drawbacks. That is, it is in particular an object of the present invention to provide a beverage preparation machine, which is more compact and which more easily refills the beverage preparation machine with a liquid such as water.

These and other objects, which become apparent upon reading the following description, are solved by the subject matter of the independent claim. The dependent claims refer to preferred embodiments of the invention.

### SUMMARY OF THE INVENTION

According to the invention, a beverage preparation machine for preparing a beverage is provided. The beverage preparation machine comprises: a machine housing for enclosing machine functional elements, which machine functional elements include at least liquid circulation pipes, a liquid pump, a liquid heater, and a beverage brewing chamber, and a liquid tank detachably arranged (i.e. a removable or detachable liquid tank) to move along a movement axis in order to be, in an inserted position, functionally inserted entirely within the machine housing such that liquid can be delivered by use of the liquid pump from the liquid tank via the liquid circulation pipes and the liquid heater to the beverage brewing chamber for mixing the liquid with a beverage ingredient contained therein, and therefore for preparing a beverage. The machine housing comprises a first opening and a second opening, which are located on opposite wall portions of the machine housing, wherein, when the liquid tank is in the inserted position, the opening is arranged to expose a part of the liquid tank such that pushing said exposed part of the liquid tank moves (in particular, slides) the liquid tank along the movement axis and out of the inserted position trough said second opening.

Hence, the liquid tank can be very easily handled to be moved into and out of the inserted position, in particular by only pushing directly on the liquid tank. Said pushing may effect a sliding movement of the liquid tank along the movement axis. Handling of the liquid tank is thus particularly advantageous with respect to use of convenience and simplicity of construction. Namely, the liquid tank does not need any dedicated handling structure or handling device, such as a handle, indentation, notch, groove, or similar, in order to move the liquid tank selectively into or out of the inserted position. Moreover, it is possible to access the liquid tank from two sides of the machine housing or of the beverage preparation machine, which sides are, for example, opposing (lateral) sides. Thus, the liquid tank is simply pushed from one of the sides to be removed (i.e. moved out of the inserted position, e.g. towards a detached state of the liquid tank), and pushed from the respective other side to be inserted (i.e. moved into the inserted position).

Further, the arrangement of the liquid tank at least partially inside of the machine housing, which machine housing is in particular dedicated for the machine functional elements of the beverage preparation machine, effects that the liquid tank can be arranged without requiring much space, thus making the beverage preparation machine more compact. This in particular for the reason that the liquid tank does not require to be arranged on an outside of the machine housing. For example, the liquid tank may be arranged at least in part in the center of the machine housing. In addition, the machine housing does not require additional parts (e.g. a lid) in order to house the liquid tank. Also, the arrangement of the liquid tank facilitates that the machine functional elements of the beverage preparation machine can be arranged with respect to the liquid tank more flexible in terms of design.

In other words, when the liquid tank, which is, for example, a water tank, is functionally in place within the beverage preparation machine, its volume is entirely contained within the housing without protruding therefrom, and traverses said housing from one wall (portion) to an opposite wall (portion) of the housing. As it traverses the housing, the liquid tank does not require any handling tool or means to be inserted in or extracted from the machine.

According to the invention, when the liquid tank is functionally inserted in the beverage preparation machine, the liquid tank is simply pushed manually on one side to initiate its extraction from the housing, and then grabbed and completely taken out of the housing from the other - e.g. extraction - wall (portion). For insertion into the machine, it is inserted into one wall of the beverage preparation machine (i.e. into one of the wall portions), preferably through the extraction wall, back into its initial position whereby its volume is entirely contained inside the machine housing.

The openings are thus arranged opposite to one another. As such, the movement axis extends through both of the openings such that the liquid tank is movable along the movement axis and through the second opening.

For example, a first wall portion of the wall portions comprises the first opening, wherein a second wall portion of the wall portions comprises the second opening. The wall portions may be lateral wall portions. For example, one of the lateral wall portions, e.g. the first wall portion, corresponds to a left wall portion or a right wall portion, when viewed onto the front or dispensing side of the beverage preparation machine. Another one of the lateral wall portions, e.g. the second wall portion, may then correspond to a right wall portion or a left wall portion. The movement axis preferably extends parallel to the horizontal, when the beverage preparation machine is arranged to prepare a beverage. In other words, the movement axis may extent laterally or along a transversal or lateral axis of the machine. As such, substantially no gravity is used for moving the liquid tank into the inserted position, making the refilling of the beverage preparation machine with the liquid tank easy and secure. In other words, only by pushing the liquid tank, the liquid tank can be moved into and out of the inserted position. Alternatively, the movement axis may extent (slightly) oblique to the horizontal, when the beverage preparation machine is arranged to prepare a beverage. An (small) inclination of the movement axis with respect to the horizontal, such as at an angle in the range from 5° to 10°, may be advantageous for using a (small) ratio of the gravity for moving the liquid tank into the inserted position, while still having a secure and easy refilling of the machine with the liquid tank. In a preferred embodiment, the liquid tank does not protrude from the machine housing, when the liquid tank is in the inserted position. In other words, the liquid tank is preferably completely arranged inside of the machine housing. This is particularly advantageous, since the machine housing thus does not require any additional means such as a lid for receiving and hiding the liquid tank in the machine housing. Preferably, the machine housing comprises a width, wherein the liquid tank extends along, or traverses, the (whole) width, when the liquid tank is in the inserted position. Thus, the beverage preparation machine is not only made compact and convenient to handle, but also adapted to contain a large amount of liquid.

The liquid tank may comprise one or more lateral ends, wherein at least one of the one or more lateral ends is at least in part flush with the machine housing (e.g. with a respective one of the wall portions), when the liquid tank is in the inserted position. For example, one of the lateral ends of the liquid tank comprises the exposed part. Thus, a very compact beverage preparation machine is provided, which at the same time has an appealing design. Further, the “accessibility sides” of the liquid tank, which are formed by the one or more lateral ends, are flat with the rest of the machine housing when it is inserted therein, i.e. when the liquid tank is in the inserted position. This provides not only compactness, but also easiness for cleaning.

The machine housing may comprise a front and a back. The front of the machine housing is usually arranged on the dispensing side of the beverage preparation machine. The liquid tank is preferably arranged to be inclined (i.e. tilted) towards the back of the machine housing, when the liquid tank is in the inserted position. With this inclined arrangement of the liquid tank, the liquid tank can be arranged in a very compact manner, for example such that at least part of the machine functional elements of the beverage preparation machine can be arranged in a space formed by said inclination of the liquid tank.

The machine housing preferably comprises a channel that is arranged at least partially inside of the machine housing to receive the liquid tank. Thus, the liquid tank is received securely and in a compact manner inside of the channel and, thus, inside of the machine housing and with respect to, if present, the machine functional elements of the beverage preparation machine.

The channel is preferably adapted to define the movement axis, e.g. by providing dedicated guiding elements. Thus, the liquid tank can be very easily moved along the movement axis and into and out of the inserted position.

The channel may be at least in part complementary formed to at least part of the liquid tank. For example, the channel comprises a sidewall portion (e.g. having a concave form), wherein the liquid tank comprises a sidewall portion, which is complementary formed to the sidewall portion of the channel (e.g. having a convex form). Thus, the channel securely receives the liquid tank. The beverage preparation machine may comprise a first connector arranged at least partially in the machine housing and a second connector arranged at least partially on the liquid tank. In the inserted position of the liquid tank, the first connector and the second connector are connected to one another for delivering liquid from the liquid tank for preparing a beverage. In other words, the connectors provide a (fluid) connection. The first connector comprises a distal end with a connection opening. When a liquid is delivered from the liquid tank, the liquid thus flows through this connection opening. The first connector is arranged such that the connection opening opens along a direction (e.g. an insertion direction for connecting the connectors with one another), which is parallel to the movement axis. In other words, the connection opening may face towards the second opening. Hence, the connectors can be connected with one another by only moving the liquid tank along the movement axis. The inserted position and, thus, the fluid connection of the liquid tank can therefore very easily effected.

The first connector and/or the second connector may comprise one or more sealing elements, such as one or more radial sealing elements, wherein the one or more sealing elements are arranged to cooperate with the respective other connector for tightly connecting (i.e. sealingly engaging) the connectors with one another, when the liquid tank is in the inserted position. In other words, the connection provided by the connectors is a fluid tight connection. Thus, a fluid tight connection between the connectors is easily achieved.

The second connector may comprise a valve adapted to move between a closed position and an open position, wherein the first connector is arranged to move the valve into the open position, when the liquid tank is moved into the inserted position, in order to connect the first connector with the second connector for delivering liquid from the liquid tank. In other words, the valve facilitates that, when the liquid tank is in a detached state, no liquid can exit the liquid tank by way of the second connector. The specific arrangement of the connectors in the inserted position of the liquid tank facilitates that the valve is only in its open position, when the liquid tank is in the inserted position.

The second connector may comprise a socket for receiving at least part of the first connector, wherein the one or more sealing elements are arranged on (i.e. on and/or in) the socket. Thus, the one or more sealing elements are arranged to provide a very effective sealing. Additionally or alternatively, a seal seat, on which the valve sits when the valve is in the closed position, may be arranged on (i.e. on and/or in) the socket. Accordingly, the valve sits on and cooperates with the seal seat to effect that, in the closed position of the valve, no liquid can flow through the second connector. Thus, the valve can be brought very easily into an engagement with at least part of the first connector.

The socket may comprise a socket opening, through which the at least part of the first connector can enter the socket for being received in the socket, wherein the seal seat is further distanced from the socket opening than the one or more sealing elements. In other words, a first distance between the socket opening and the seal seat is greater than a second distance between the socket opening and the one or more sealing elements. Thus, when moving the liquid tank into the inserted position, the first connector will initially come into a sealing engagement with the one or more sealing elements, before coming into contact with the valve for moving the valve into the open position. Hence, the one or more sealing elements provide a sealing (i.e. a pre-sealing) before the valve of the second connector is in the open position. This effects a very good sealing, preventing that in any position of the liquid tank inside of the machine housing (in particular in a position close to the inserted position) the liquid flows towards parts of the machine other than into the first fluid connector.

The liquid tank may comprise a transparent part and an opaque part. The transparent part may be arranged such that a user can easily see, via the transparent part, the filling level of the liquid contained in the liquid tank. When the liquid tank is in the inserted position and when viewed at least along the movement axis, and preferably along one or more axes oblique to the movement axis, the opaque part is arranged to obstruct a view onto one or more parts arranged inside of the machine housing. These one or more parts may include, for example, the first connector and/or the second connector. Thus, the one or more parts arranged inside of the machine housing are obscured or hidden without requiring additional parts such as machine housing parts or a lid. For example, only a dedicated part of the transparent liquid tank may be made opaque (e.g. by applying a coating) for providing the opaque part of the liquid tank.

In a preferred embodiment, the (plurality of) machine functional elements adapted for preparing a beverage (is) are arranged in the machine housing. The machine functional elements may comprise one or more of the following: a brewing chamber, a brewing unit, a liquid heater, a control unit, a liquid pump, a capsule holder, one or more liquid circulation pipes, electronics, and combinations thereof.

At least part or all of the machine functional elements may span a space, wherein the liquid tank is at least partially arranged inside of the space, when the liquid tank is in the inserted position. This arrangement of the liquid tank effects that the liquid tank can be arranged without requiring much space, thus making the beverage preparation machine more compact.

The machine functional elements may be arranged around the movement axis. Additionally or alternatively, when viewed along and/or perpendicular to the movement axis, the movement axis and/or, in the inserted position of the liquid tank, at least part of the liquid tank may be arranged between two of the machine functional elements. Thus, a very compact arrangement of the machine functional elements with respect to the movement axis and/or the liquid tank is achieved.

### BRIEF DESCRIPTION OF THE DRAWINGS

Additional features and advantages of the present invention are described in, and will be apparent from, the description of the presently preferred embodiments which are set out below with reference to the drawings in which :

FIG. 1 is a schematic side view of a beverage preparation machine according to a preferred embodiment of the invention;

FIG. 2 is a schematic front view of the beverage preparation machine according to FIG. 1;

FIG. 3A is a schematic perspective view of a beverage preparation machine according to a further preferred embodiment;

FIGS. 3B and 3C are perspective side views of the machine of FIG. 3A;

FIG. 3D is a view of the machine of FIGS. 3A-3C whit the liquid tank put aside;

FIGS. 4A-4E are different views of a preferred detachable liquid tank;

FIG. 5 is a schematic cross-sectional view of a beverage preparation machine according to a preferred embodiment, in which the liquid tank is detached from the machine housing (i.e. detached state of the liquid tank);

FIG. 6 is a schematic cross-sectional view of the beverage preparation machine shown in FIG. 5, wherein the liquid tank is partially inserted into the machine housing (intermediate position of the liquid tank);

FIG. 7 is a schematic cross-sectional view of the beverage preparation machine shown in FIGS. 5 and 6, wherein the liquid tank is in the inserted position; and

FIG. 8 is a schematic detailed view of FIG. 7, showing the connection between the first connector and the second connector.

### DETAILED DESCRIPTION OF THE INVENTION

In the figures, preferred embodiments of a beverage preparation machine 1 according to the present invention are exemplarily shown. The beverage preparation machine 1 is adapted for preparing a beverage. The beverage may be, for example, a coffee, a tea, a hot chocolate, and/or any other beverage or drink. The beverage may be a chilled or hot beverage. The beverage preparation machine 1 may be adapted to prepare a beverage from a container or capsule. The capsule (or container) usually contains the (beverage brewing) ingredients for preparing the beverage, such as ground coffee and/or chocolate and/or milk powder. The beverage preparation machine 1 is not restricted to any specific design. Preferably, the beverage preparation machine 1 is designed to be used in a household such as in a kitchen. The beverage preparation machine 1 may have a design suitable to be placed on a tabletop or the same.

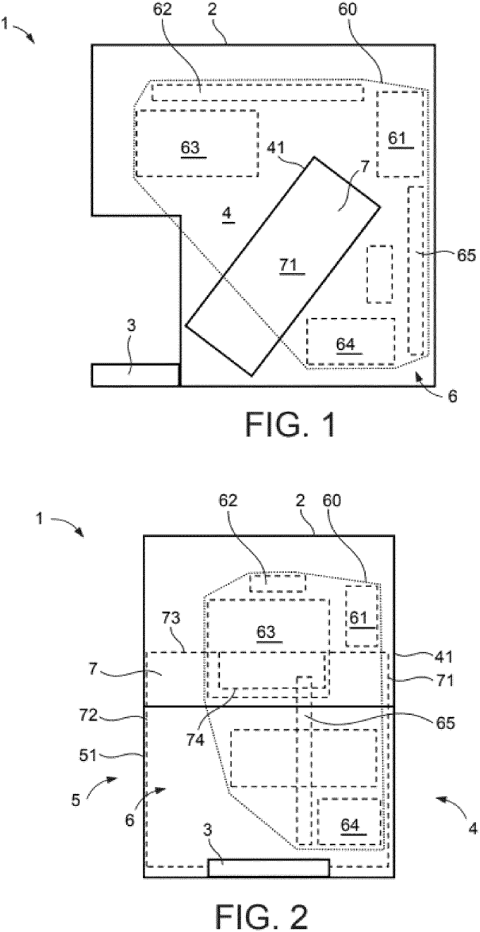

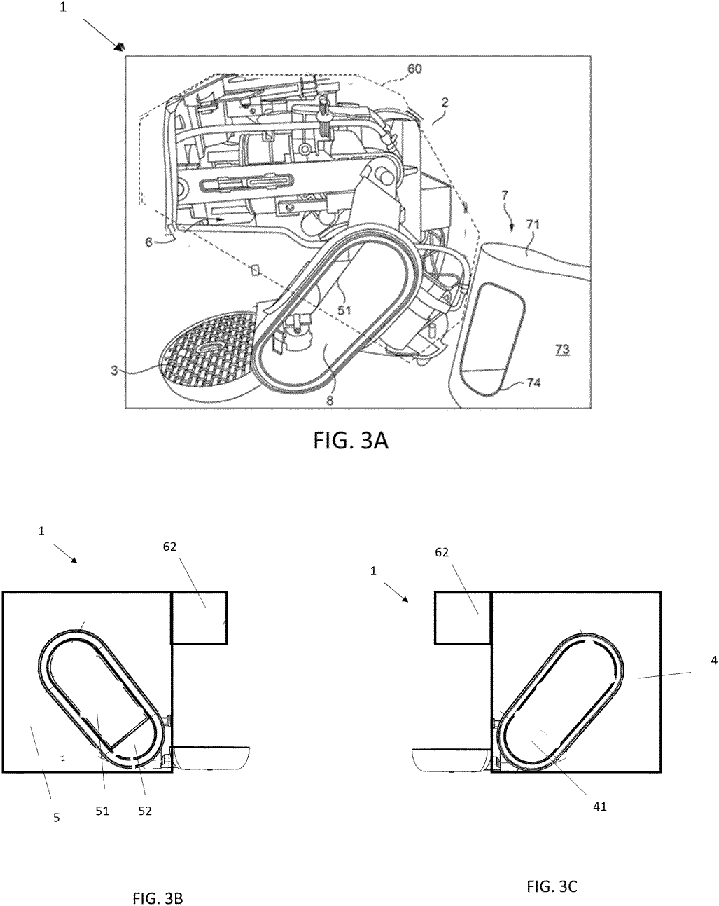

As shown in FIGS. 1 and 2, the beverage preparation machine 1 comprises a machine housing 2 (i.e. a machine casing) for enclosing machine functional elements 6. The machine housing 2 is not limited to a particular form. The machine housing 2 in particular includes a bottom and a top. By means of the bottom of the machine housing 2, the beverage preparation machine 1 can be put in a position, in which the beverage preparation machine 1 can prepare a beverage. The machine housing 2 may comprise a front (see, for example, FIG. 2). The front of the machine housing 2 typically corresponds to the dispensing side of the beverage preparation machine 1. The “dispensing side” is to be understood broadly, in particular not limited to a specific form. The dispensing side may be the side of the beverage preparation machine 1, where the beverage is dispensed and/or where the user inputs one or more user requests (e.g. via a user interface) into the beverage preparation machine 1. The front of the machine housing 2, or the dispensing side of the beverage preparation machine 1, may comprise a support 3 onto which a container, such as a cup, can be placed such that the beverage preparation machine 1 can dispense the beverage into said container. The support 3 may be adapted to receive liquid (e.g. residual liquid) dispensed by the beverage preparation machine 1. The (residual) liquid may then flow into a dedicated and preferably detachable container for collecting the (residual) liquid. The support 3 may comprise a tray, such as a drip tray.

The machine housing 2 may comprise a back. The back is arranged opposite to the front. The back of the machine housing 2 may comprise, for example, connection means, such as a power plug, for supplying the beverage preparation machine 1 with energy or power. The machine housing 2 may comprise one or more lateral sides, e.g. a left side and a right side. When viewed onto the front of the machine housing 2, the one or more lateral sides are arranged laterally with respect to the machine housing 2, e.g. on a left side or a right side. A “side” is to be understood broadly, in particular not limited to a specific form. The one or more lateral sides may be arranged between the bottom and the top of the machine housing 2 and/or between the front and the back of the machine housing 2.

The machine housing 2 may comprise a wall (e.g. sidewall) portion 4 (also referred to as “second wall portion”), which is optionally a lateral wall portion. As shown in FIG. 2, the lateral wall portion 4 is arranged laterally with respect to the machine housing 2, e.g. on a lateral side such as the right side of the machine housing 2. The wall portion 4 is not limited to a specific form. In a cross-sectional view, the wall portion 4 may have a straight and/or arcuate form. As shown in FIG. 1, the wall portion 4 may be arranged between the bottom and the top of the machine housing 2, when viewed in a lateral side view of the machine housing 2 or beverage preparation machine 1, i.e. when viewed along the lateral or transversal axis of the beverage preparation machine 1. As shown in FIG. 2, the machine housing 2 comprises a (further) wall (e.g. sidewall) portion 5 (also referred to as “first wall portion”) arranged opposite to the wall portion 4. The wall portion 4 is optionally a lateral wall portion. The further lateral wall portion 5 is arranged laterally with respect to the machine housing 2, such as on a lateral side of the machine housing 2, e.g. a left side of the machine housing 2, as shown in FIG. 2. As for the wall portion 4, the further wall portion 5 is not limited to a specific form. In a cross-sectional view, the further wall portion 5 may have a straight and/or arcuate form. The further wall portion 5 may be arranged between the bottom and the top of the machine housing 2, when viewed in a lateral side view of the machine housing 2. The wall portions 4 and 5 may delimit a space, which is dedicated for a plurality of machine functional elements, as further described below. The machine housing 2 may consist of the wall portions 4, 5.

Hence, the beverage preparation machine 1 and/or the machine housing 2 may have a longitudinal (front) axis, a transversal (side or width) axis, and/or a vertical (height) axis. The longitudinal axis extends from the front to the back of the machine housing 2, the transversal axis extends from a lateral side (e.g. left side) to another lateral side (e.g. right side) of the machine housing 2, and the vertical axis extends from the bottom to the top of the machine housing 2.

The beverage preparation machine 1 may comprise a plurality of machine functional elements 6, adapted for preparing a beverage. Each of the machine functional elements 6 is thus a functional component or element, adapted for carrying out a respective function (e.g. heating, liquid conveyance, liquid moving, controlling) for preparing the beverage. The plurality of machine functional elements 6 is arranged in the machine housing 2, preferably in a space 60 of the machine housing 2, which is shown in FIGS. 1, 2 and 3A in dotted lines. Thus, the housing 2 and, preferably, said space 60 houses or encloses the plurality of machine functional elements. The “space” of the machine housing 2 is to be understood as a space or volume, which is spanned by the plurality of machine functional elements arranged in the machine housing 2. In other words, the space 60 corresponds to an imaginary single shell, which wraps the plurality of machine functional elements 6 in such a way that the volume delimited by the shell is spanned only by the machine functional elements 6. For example, two machine functional elements span a space, which extends at least from one of the machine functional elements 6 to the other one of the machine functional elements 6. If, for example, a third machine functional element is provided, the space does not only extend between the two machine functional elements, but also towards the third machine functional element. In FIG. 1, it is exemplarily shown how the space 60 is spanned by the machine functional elements 61-65. Preferably, the wall portion 4, and preferably the further wall portion 5, is arranged to cover at least part of the plurality of machine functional elements 6. For example, the plurality of machine functional elements 6 is arranged in the space defined by the wall portions 4, 5. In FIGS. 1 and 2, the machine functional elements 6 are covered by the machine housing 2, i.e. at least by the wall portion 4 and preferably also by the further wall portion 5, and are thus shown in dashed lines. At least part of the machine functional elements 6 are arranged next to one another, and/or one or more of the machine functional elements 6 are arranged between at least two of the machine functional elements 6. For example, a part of the machine functional elements 6 is arranged in a lower part of the beverage preparation machine 1, wherein another part of the machine functional elements 6 is arranged in an upper part of the beverage preparation machine 1.

The machine functional elements 6 may comprise one or more of the following machine functional elements: a beverage brewing chamber, a brewing unit, a liquid heater, a liquid pump, a capsule holder, a control unit, one or more pipes (i.e. one or more liquid circulation pipes or lines), electronics, and combinations thereof. For example, the pump may be arranged to deliver a liquid to the liquid heater, which then heats up the liquid to have a temperature suitable for preparing a beverage. The liquid heater may be an in-line heater and/or a heat accumulation structure, such as a thermo block. The beverage brewing chamber may be part of a capsule holder and/or a brewing unit thereof. The beverage brewing chamber is preferably adapted to receive the beverage ingredient, e.g. contained in a container. For example, the beverage brewing chamber and/or the capsule holder and/or the brewing unit comprises opening means, which are adapted to open the received capsule such that liquid can enter the capsule and/or exit the capsule. The liquid, heated up by the liquid heater, is delivered, by the pump, to the beverage brewing chamber, where the liquid is injected into the respective capsule in order to prepare the beverage. For example, by injecting the liquid into the capsule, a coffee extraction is carried out. The control unit may be arranged to control, for example based on one or more user requests, one more of the following: the beverage brewing chamber, the brewing unit, the liquid heater, the liquid pump, the capsule holder, the electronics, and combinations thereof. The liquid connection between the respective machine functional elements may be provided by the one or more pipes. The electronics may be provided in addition to one or more of the machine functional elements 6, e.g. for providing a monitoring function (maintenance, filling level, scale deposition, etc.) of the respective machine functional element.

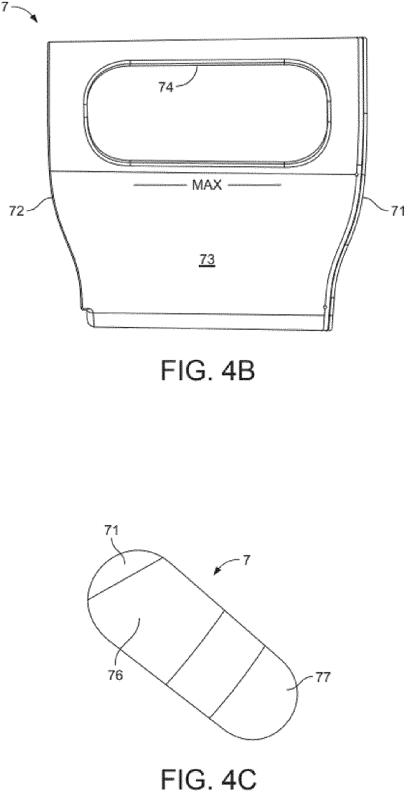

The beverage preparation machine 1 further comprises a liquid tank 7. The liquid tank 7 is arranged to be inserted into the machine housing 2. The liquid tank 7 is adapted to store or contain a defined amount of liquid, such as water or any other liquid, e.g. milk. Thus, the liquid tank 7 may be a water tank. The liquid tank 7 comprises a liquid tank body, which is adapted to store the liquid. The defined amount of liquid may correspond to a specific number of beverages to be dispensed by the beverage preparation machine 1. For example, the liquid tank 7 is adapted to contain at least 1L of the liquid. The liquid tank 7 is not limited to a specific form. The liquid tank 7 may have an asymmetric or symmetric form. The liquid tank 7 may at least in part have a round form and/or straight form. As shown in FIGS. 4A-4D, the liquid tank 7 may be at least in part roundly formed and in part straightly formed.

The liquid tank 7 may comprise one or more lateral ends 71, 72. The one or more lateral ends 71, 72 may be arranged to at least partially delimit the space (or body) of the liquid tank 7, which is adapted to contain (or store) the liquid in the liquid tank 7. The lateral ends 71, 72 may be arranged opposite to one another. The liquid tank 7 may comprise a sidewall 73, which at least partially delimits the space of the liquid tank 7, which stores the liquid in the liquid tank 7. For example, the sidewall 73 is a circumferential sidewall. The sidewall 73 may extend at least from the lateral end 71 to the lateral end 72. The one or more lateral ends 71, 72 and the sidewall 73 preferably delimit the space of the liquid tank 7, which is dedicated for the liquid. The liquid tank 7 may comprise a filling opening 74, through which the liquid tank 7 can be filled with a liquid, such as with water from the tap. Preferably, the sidewall 73 comprises the filling opening 74, and/or the filling opening 74 is arranged between the lateral ends 71, 72.

Preferably, the filling opening 74 is designed so that it is possible to partly withdraw the tank 7 from the channel 8 to enable a free access to this opening and to enable a user to refill the tank with water without totally removing the tank from the machine.

The liquid tank 7 is a detachably arranged liquid tank. That is, the liquid tank 7 is detachably arranged (i.e. removable and/or insertable) to move along a (specific or defined) movement axis in order to be moved into an inserted position. The inserted position is exemplarily shown in FIGS. 1 and 2. In the inserted position of the liquid tank 7, the liquid tank 7 is functionally inserted entirely within the machine housing 2. Thus, liquid can be delivered from the liquid tank 7 to the beverage brewing chamber for mixing with a beverage ingredient contained therein, and therefore for preparing a beverage. In the inserted position of liquid tank 7, the liquid pump as part of the machine functional elements 6 is arranged to deliver (preferably draw) liquid from the liquid tank 7 via the liquid circulation pipes and the liquid heater to the beverage brewing chamber. The beverage brewing chamber may be part of a brewing unit and/or a capsule holder thereof. In the beverage brewing chamber, the liquid comes into contact with the beverage ingredient (ground coffee, chocolate, milk, etc.) contained therein for preparing the beverage. The liquid tank 7 may be movable out of the inserted position and, thus, into a detached state. In the detached state of the liquid tank 7, the liquid tank 7 is detached from the machine housing 2. In the detached state of the liquid tank 7, the liquid tank 7 may be arranged completely outside of the machine housing 2 so that the liquid tank 7 can be, in particular, grasped by one or two hands of the user operating the beverage preparation machine 1 in order to move the liquid tank 7 freely in the space. For example, in the detached state of the liquid tank 7, the liquid tank 7 can be refilled with a liquid and/or cleaned.

When the liquid tank 7 is in the inserted position, the liquid tank 7 may be at least partially arranged inside of the space 60. In other words, at least part of the liquid tank 7 may be arranged between two machine functional elements 6, when viewed along the movement axis. For example, and as shown in FIG. 1, the liquid tank 7 is arranged at least partially between the machine functional elements 63 and 64 in order to be arranged at least partially inside of the space 60. In the inserted position of the liquid tank 7, one of the machine functional elements 6 may be arranged to face a first side of the liquid tank 7, wherein another one of the machine functional elements 6 may be arranged to face a second side of the liquid tank 7. The first side and the second side of the liquid tank 7 may be oppositely arranged sides. The sidewall 73 of the liquid tank 7 may comprise said first and second side. Arranging the liquid tank 7 in its inserted position to be at least partially arranged inside of the space 60 effects that the liquid tank 7 is arranged without requiring much space. Hence, the beverage preparation machine 1 can be made compact.

Certain arrangements of the movement axis with respect to the machine functional elements 6 and/or the space 60 may make the beverage preparation machine 1 even more compact. For example, the movement axis may be arranged to extend through the space 60. Additionally or alternatively, and when viewed along the movement axis, as shown in FIG. 1, the movement axis may be arranged between two machine functional elements 6, such as between the machine functional elements 63 and 64. Additionally or alternatively, and when viewed perpendicular to the movement axis, such as in a top view or a front view of the beverage preparation machine 1 (see, for example, FIG. 2), the movement axis may be arranged between two machine functional elements 6, such as between the machine functional elements 61 and 64. Additionally or alternatively, arranging the machine functional elements 6 (all) around the movement axis also effects that the beverage preparation machine 1 is made more compact. When the beverage preparation machine 1 is arranged to prepare a beverage, e.g. when the beverage preparation machine 1 is in a state (position and/or orientation) ready for dispensing a beverage, the movement axis may extend parallel or (slightly) oblique (e.g. at an angle from 0° to 10°, preferably from 5° to 10°) with respect to the horizontal. In other words, the movement axis may be substantially a transversal axis. Having the movement axis only parallel to the horizontal effects advantageously that gravity is not required for moving the liquid tank 7 into the inserted position, in particular improving the handling of the liquid tank 7. Further, since the liquid tank 7 is not required to move along the vertical, the beverage preparation machine 1 requires less space above the top of the machine housing 2. The beverage preparation machine 1 can thus be arranged without requiring much space, in particular with respect to the vertical.

As shown in FIG. 1, the wall portion 4 comprises an opening 41 (also referred to as “second opening”). The wall portion 4 may at least in part delimit the opening 41. Preferably, the wall portion 4 surrounds the opening 41 on all sides in order to delimit the opening 41. The opening 41 is adapted such that the liquid tank 7 can be moved through this opening 41. Further, the opening 41 is arranged such that the movement axis extends through this opening 41. Thus, by moving the liquid tank 7 along the movement axis and, thus, through the opening 41, the liquid tank 7 can be moved into the inserted position. Preferably, the liquid tank 7 does not protrude from the machine housing 2, when the liquid tank 7 is in the inserted position. Thus, the liquid tank 7 is, in the inserted position, completely arranged in the machine housing 2. In the inserted position of the liquid tank 7, the liquid tank 7 preferably does not protrude out of the opening 41. In a particularly preferred embodiment, the lateral end 71 is, when the liquid tank 7 is in the inserted position, at least in part flush with the machine housing 2, such as with the wall portion 4.

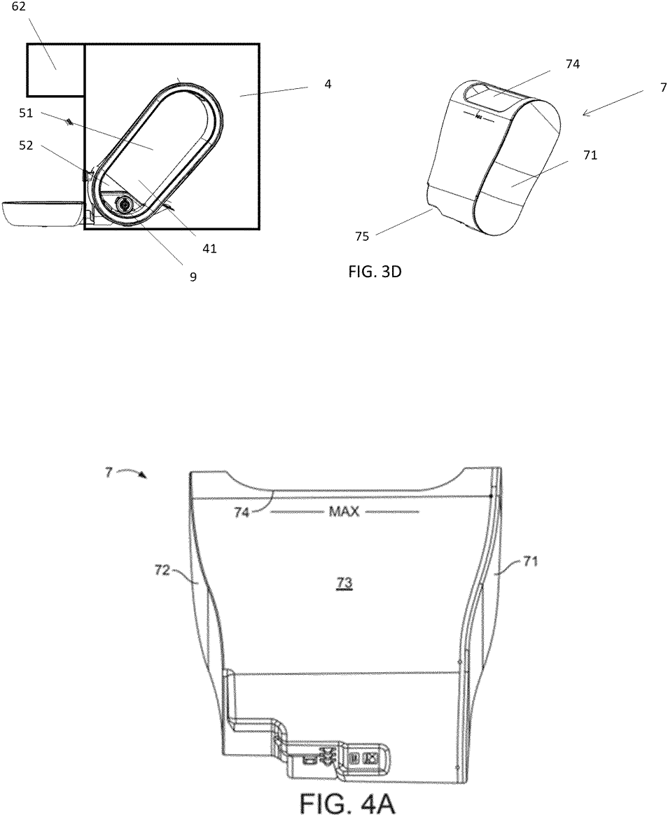

In the inserted position of the liquid tank 7, the orientation of the liquid tank 7 with respect to the machine housing 2 may have a further advantageous effect on the compaction of the beverage preparation machine 1. As exemplarily shown in FIGS. 1 and 3A-3D, the liquid tank 7 may be arranged to be inclined towards the back of the machine housing 2, when the liquid tank 7 is in the inserted position. That is, the liquid tank 7 may extend not only along a longitudinal, but also along a height axis, which height axis extends perpendicular to the longitudinal axis; the longitudinal axis extends, in the inserted position, parallel to the movement axis. In the inserted position of the liquid tank 7, the height axis of the liquid tank 7 may thus extend oblique with respect to the vertical in order to have the liquid tank 7 inclined (i.e. tilted) towards the back of the machine housing 2. Thus, the liquid tank 7 is tilted relative to, for example, the longitudinal axis; as such, the top of the liquid tank 7 is moved backwards relative to its bottom. In this inclined state of the machine housing 2 in the inserted position, the machine functional elements 6 can be effectively arranged in the machine housing 2. Preferably, the height axis is arranged to the vertical at an angle from 30° to 50°, in particular at an angle of about 45°. The arrangement of the filling opening 74 may be such that the filling opening 74 extends at least at a point of the liquid tank 7, which forms the peak of the liquid tank 7, when the liquid tank 7 is in the inserted position and the before-mentioned inclined state. Thus, a particularly great amount of liquid can be stored in the liquid tank 7, even though the liquid tank 7 is arranged in an inclined state for compaction of the beverage preparation machine 1.

As in particular shown in FIG. 3A, the machine housing 2 may comprise a channel 8. The channel 8 is adapted for receiving the liquid tank 7. For example, the channel 8 is adapted to define the movement axis. The channel 8 may comprise guiding structures, which facilitate to move or slide the liquid tank 7 along these guiding structures and, thus, along the movement axis. The guiding structures may be arranged on an inner side of the channel 8, which faces the liquid tank 7, when in the inserted position. Preferably, the channel 8 is at least in part complementary formed to at least part of the liquid tank 2, e.g. to an outer wall of the liquid tank 2; for example, the sidewall 73 of the liquid tank 7 comprises this outer wall. Thus, at least part of the channel 8 may be formed concave, wherein part of the liquid tank 7 is complementary formed to this concave part, thereby having a convex form. The channel 8 is arranged at least partially inside of the machine housing 2, preferably of the space 60, so that when the liquid tank 7 is arranged in the channel 8, the liquid tank 7 is at least partially arranged inside of the machine housing 2 or space 60. The opening 41 is preferably arranged to join to the channel 8. For example, the channel 8 extends from the opening 41.

As shown in FIGS. 1 and 3B, the machine housing 2 comprises an opening 51 (also referred to as “first opening”) for an easy detachment of the liquid tank 7 from the machine housing 2, i.e. for easily moving the liquid tank 7 out of the inserted position. The opening 51 is arranged to expose a part of the liquid tank 7, when the liquid tank 7 is in the inserted position. This exposed part of the liquid tank 7 may be at least part of the lateral end 72. The arrangement of the opening 51 is such that, when the liquid tank 7 is in the inserted position, pushing said exposed part by the hand of a user, who operates the beverage preparation machine 1, moves the liquid tank 7 along the movement axis and out of the inserted position, e.g. through the opening 41 and/or towards a detached state of the liquid tank 7.

With reference to FIG. 2, pushing said exposed part of the liquid tank 7 by way of the opening 51 effects that the liquid tank 7 is moved along a left-right-direction, i.e. towards the right. The opening 51 is optionally arranged opposite to the opening 41 and wall portion 4. Preferably, the opening 51 is arranged in the wall portion 5. The wall portion 5 may at least in part delimit the opening 51. Preferably, the wall portion 5 surrounds the opening 51 on all sides in order to delimit the opening 51. The opening 51 may be adapted such that the liquid tank 7 cannot be moved through this opening 51. For example, the opening 51 is smaller than the height of the liquid tank 7; the height of the liquid tank 7 is measured along an axis, which is perpendicular to the movement axis. Or as illustrated in FIG. 3B, a closing part 52 is provided to stop the movement of the thank through the channel. As sown in FIG. 3A, this closing part can also be configured to support the connection of the connector 10 of the tank to the second connector 9. Having the opening 51 to expose the at least part of the liquid tank 7 in the inserted position particularly effects that no complex handling structure (handle, protrusion, indentation, etc.) needs to be provided for the liquid tank 7 in order to move the liquid tank selectively into the inserted position or out of the inserted position. In particular, the one or more lateral ends 71, 72 can be designed simply, such as to extend only smoothly or continuously. In the inserted position of the liquid tank 7, the lateral end 72 is preferably flush with at least part of the machine housing 2, such as with the wall portion 5. If the movement axis extends parallel or slightly oblique to the horizontal, when the beverage preparation machine 1 is arranged to prepare a beverage, moving the liquid tank 7 out of the inserted position is very easy, since the liquid tank 7 is not or only partially required to move along the vertical and, thus, against the gravity or weight force of the liquid tank 7.

In the inserted position of the liquid tank 7, liquid can be delivered from the liquid tank 7, e.g. by use of the liquid pump. Thus, the liquid tank 7 is in fluid communication with at least part of the machine functional elements 6. For example, and as in particular shown in FIGS. 3D and 5-8, the beverage preparation machine 1 may comprise a first connector 9 arranged at least partially in the machine housing 2. Preferably, the first connector 9 extends at least partially inside of the channel 8 and/or at a bottom side of the machine housing 2, e.g. next to the support 3. Further, the beverage preparation machine 1 may comprise a second connector 10, arranged at least partially on the liquid tank 7. Preferably, the second connector 10 is not arranged on the lateral ends 71, 72 of the liquid tank 7. For example, a part of the wall 73 extends to descend from the lateral end 71 to the lateral end 72, forming a stepped region 75. The stepped region 75 may at least partially comprises the second connector 10.

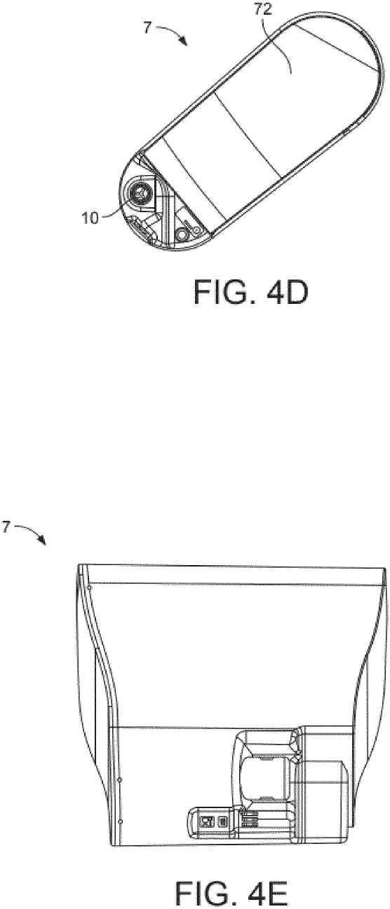

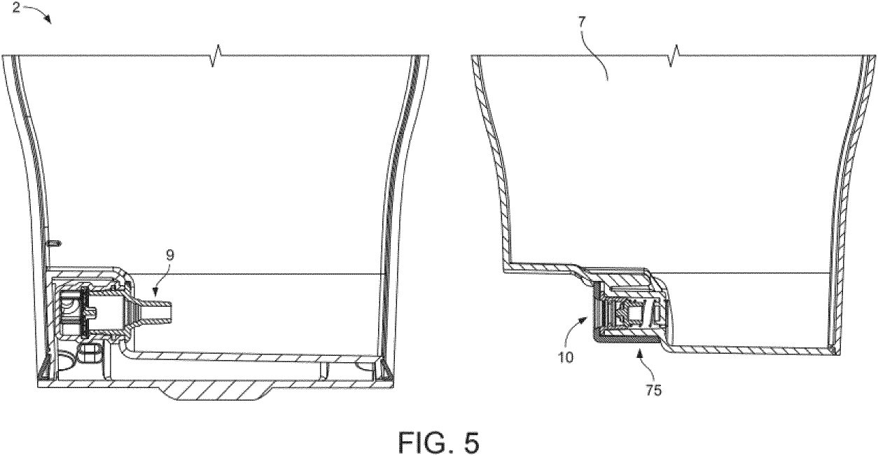

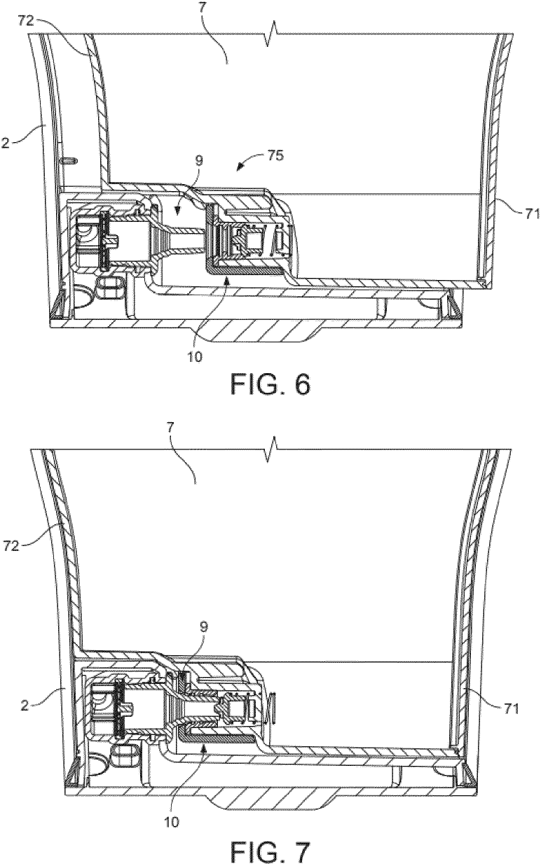

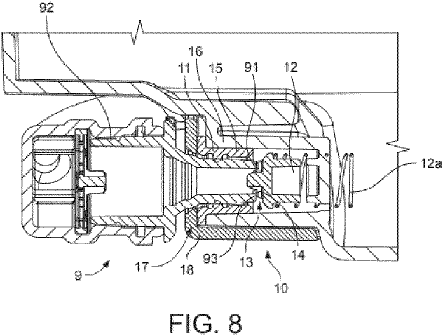

When the liquid tank 7 is not in the inserted position, as shown, for example, in FIGS. 5 and 6, the connectors 9, 10 are distanced from one another, so that no liquid can be delivered from the liquid tank 7 for preparing a beverage. When the liquid tank 7 is in the inserted position, as shown in FIGS. 7 and 8, the first connector 9 and the second connector 10 are connected to one another. Thus, liquid can be delivered from the liquid tank 7 for preparing a beverage. As shown in, for example, FIG. 7, in the inserted position of the liquid tank 7, the first connector 9 may be arranged in the free space effected by the stepped region 75. Said free space is at least in part delimited by the riser and the tread of the step of the stepped region 75. The riser comprises preferably at least part of the second connector 10. Thus, the first connector 9 and the second connector 10 can be connected to one another without requiring much space.

The first connector 9 may comprise a distal end 91. The first connector 9 may also have a proximal end 92, which fluidly connects to the machine housing 2, e.g. with a liquid pump and/or one or more liquid circulation pipes. Thus, the distal end 91 is positioned away from the point, where the first connector 9 is connected to the machine housing 2. The distal end 91 comprises a connection opening 93. The connection opening 93 is the opening of the first connector 9, through which the liquid, delivered from the liquid tank 7, is flowing, when the liquid tank 7 is in the inserted position. As shown in, for example, FIG. 5, the arrangement of the first connector 9 is preferably such that the opening 93 opens along a direction, which is parallel to the movement axis. Thus, when viewed along the movement axis and through the opening 41, the connection opening 93 is visible, when the liquid tank 7 is not in the inserted position. In other words, the first connector 9 and/or the opening 93 define/s an insertion direction, along which the first connector 91 can be connected to the second connector 93, wherein this insertion direction is parallel to the movement axis. Thus, a user of the beverage preparation machine 1 only needs to move the liquid tank 7 along the movement axis in order to connect the connectors 9, 10 with one another. Hence, the fluid connection between the connectors 9, 10 can be very conveniently provided.

As particularly apparent from FIG. 8, the second connector 10 preferably comprises one or more sealing elements 11, such as one or more radial sealing elements. The one or more sealing elements 11 are arranged to cooperate with the first connector 9 for tightly, or sealingly, connecting the connectors 9, 10 with one another, when the liquid tank 7 is in the inserted position. For example, the one or more sealing elements 11 are, in the inserted position of the liquid tank 7, in sealing contact with the first fluid connector 9 in order to seal a (circumferential) gap between the first connector 9 and the second connector 10. In a preferred embodiment as shown in FIG. 8, the one or more sealing elements 11 may be arranged to come into sealing contact or engagement with an outer wall of the first fluid connector 9. Additionally or alternatively, the first connector 9 may comprise the one or more sealing elements 11, e.g. being in sealing contact or engagement with an inner wall of the second connector 10 when the liquid tank 7 is in the inserted position.

The second connector 9 of the liquid tank 7 may comprise a valve 12. The valve 12 is in particular arranged to prevent that, in a detached state and/or a non-inserted position of the liquid tank 7, liquid flows by way of the second connector 10 out of the liquid tank 7. As shown in, in particular, FIGS. 6 and 8, the valve 12 is adapted to move between a closed position (see, for example, FIG. 6) and an open position (see, for example, FIG. 8). For example, the valve 12 may be linearly movable between the closed position and the open position, and/or the valve 12 may be formed as and/or movable like a piston. When the valve 12 is in the closed position, no liquid can flow from the liquid tank 7 by way of the second connector 10 to an outside of the liquid tank 7. In the closed position of the valve 12, the liquid tank 7 can be moved out of the inserted position, e.g. into a detached state, where the liquid tank 7 is filled with a liquid, e.g. via the filling opening 74. In the open position of the valve 12, liquid can flow from the liquid tank 7 via the second connector 10 to an outside of the liquid tank 7, in particular into the first connector 9.

In the inserted position of the liquid tank 7, the arrangement of the connectors 9, 10 with respect to one another is preferably such that the first connector 9 moves the valve 12 into its open position. This open position is exemplarily shown in FIG. 8. As apparent from FIG. 8, the distal end 91 may come into contact with the valve 12 in order to move the valve 12 towards and into the open position. During this contact between the distal end 91 and the valve 12, a gap 13 may be formed between the distal end 91 and the valve 12. Thus, the liquid can flow from the liquid tank 7 and by way of the gap 13 into the opening 93, thereby providing the liquid connection between the first connector 9 and the second connector 10. For example, the valve 12 comprises on its side, which faces the distal end 91 of the first connector 9, a protrusion 14, which is arranged to come into contact with the distal end 91 for moving the valve 12 into its open position. Once the valve 12 is in its open position, the protrusion 14 thus at least partially delimits the gap 13.

The valve 12 is preferably biased towards the closed position. For example, the valve 12 may comprise an elastic element 12a, such as a spring element, which is arranged to bias the valve 12 into the closed position. In the closed position, the valve 12 preferably sits on a seal seat 15. Thus, the valve 12 is preferably biased towards the seal seat 15 in order to have the valve 12 in the closed position. In the open position of the valve 12, a gap is formed between the seal seat 15 and the valve 12. Thus, liquid can flow through said gap and towards the first fluid connector 9, such as into the gap 13 and opening 93.

The first connector 9 and the second connector 10 may be connected to one another by providing the connectors 9, 10 as mating connectors. For example, one of the connectors 9, 10 is a male connector, wherein the respective other one of the connectors 9, 10 is a female connector. As shown in FIG. 8, the second connector 10 may be a female connector, and the first connector 9 may be a male connector, or vice versa. Preferably, the second connector 10 comprises a socket (or receptacle) 16, in which at least part of the first connector 9, such as at least the distal end 91, is received, in particular when the liquid tank 7 is in the inserted position or when the connectors 9, 10 are at least partially connected to one another, e.g. when the liquid tank 7 is in an intermediate position close to the inserted position. For example, in the intermediate position the distal end 91 is received in the socket 16, but not yet in contact with the valve 12.

The one or more sealing elements 11 may be arranged on (i.e. on and/or in) the socket 16, in particular on an inner wall of the socket 16 facing an outer wall of the first connector 9. Additionally or alternatively, the seal seat 15 may be arranged on (i.e. on and/or in) the socket 16, in particular on an inner wall of the socket 16 facing an outer wall of the first connector 9. The one or more sealing elements 11 and the seal seat 15 may be integrally formed with one another. Thus, the one or more sealing elements 11 and the seal seat 15 may form a single piece. As such, production costs can be reduced. In particular, the one or more sealing elements 11 and the seal seat 15 do not need to be arranged on the socket 16 independent from one another. Rather, the one or more sealing elements 11 and the seal seat 15 can be arranged collectively on the socket 11 in a single step.

The socket 16 may comprise a socket opening 17, through which the at least part of the first connector 9, such as at least the distal end 91, can enter the socket 16 for being received in the socket 16. Preferably, the seal seat 15 is further distanced from the socket opening 17 than the one or more sealing elements 11. Thus, when connecting the connectors 9 and 10 with one another, the first connector 9 comes into contact with the one or more sealing elements 11 before coming into contact with the valve 12. Such a state before contacting the valve 12 is, for example, the above-mentioned intermediate position. This provides the advantage that the connectors 9, 10 are tightly connected to one another before the valve 12 is moved by the first connector 9 into the open position. In other words, the one or more sealing elements 11 provide a pre-sealing. Preferably, the liquid tank 7 comprises a cover 18, such as a sealing cover, which is arranged to at least partially cover the socket 16. For example, the cover 18 is mounted or plugged on the socket 16. The cover 18 may be arranged such that at least part of the one or more sealing elements 11, such as a flange or collar integrally formed with the one or more sealing elements 11, is arranged or sandwiched between the socket 16 and the cover 18. Thus, a gap between the socket 16 and the cover 18 can be effectively sealed.

The liquid tank 7 may be designed to obstruct the view onto one or more parts of the beverage preparation machine 1, which are arranged inside of the machine housing 2, such as onto the first connector 9 and/or the second connector 10 and/or one or more of the machine functional elements 6. This provides the advantage that the number of parts of the machine housing 2, which conceal the respective parts of the beverage preparation machine 1, can be reduced. Preferably, the liquid tank 7 comprises a transparent part 76 and an opaque part 77. The transparent part 76 is preferably designed such that the filling level of the liquid contained in the liquid tank 7 is visible through the transparent part 76. The transparent part 76 may be formed in one or more of the lateral ends 71, 72, preferably at least in the lateral end 71. The opaque part 77 is arranged such that the opaque part 77 obstructs a view onto the one or more parts, e.g. the first connector 9 and/or the second connector 10, when the liquid tank 7 is in the inserted position and when viewed at least along the movement axis, such as through the opening 41. The opaque part 77 may be formed in one or more of the lateral ends 71, 72, preferably in the lateral end 71. For example, the lateral end 71 consists of the transparent part 76 and the opaque part 77. The lateral end 71 may be initially completely transparent, wherein the opaque part 77 is provided by applying an opaque structure, such as in form of a coating, onto the transparent lateral end 71. The transparent part 76 is thus the part of the lateral end 71, which remains, after said application, transparent. The lateral end 71 may be also provided in several parts such as in two parts. One of the parts may thus correspond to the transparent part 76, wherein another one of the parts corresponds to the opaque part 77.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

List of references in the drawings :

| | |
|---|---|
| machine | 1 |
| housing | 2 |
| cup support | 3 |
| second wall portion | 4 |
| opening | 41 |
| first wall portion | 5 |
| opening | 51 |
| closing part | 52 |
| functional elements | 6, 61, 63, 64 |
| dispensing nozzle | 62 |
| space | 60 |
| tank | 7 |
| lateral ends | 71, 72 |
| side wall | 73 |
| filling opening | 74 |
| stepped region | 75 |
| transparent part | 76 |
| opaque part | 77 |
| channel | 8 |
| first connector | 9 |
| distal end | 91 |
| proximal end | 92 |
| opening | 93 |
| second connector | 10 |
| sealing elements | 11 |
| valve | 12 |
| elastic element | 12 a |
| gap | 13 |
| protrusion | 14 |
| seal seat | 15 |
| socket | 16 |
| opening | 17 |
| cover | 18 |

1. A beverage preparation machine, comprising:
a machine housing for enclosing machine functional elements, which machine functional elements include at least liquid circulation pipes, a liquid pump, a liquid heater, and a beverage brewing chamber, and
a liquid tank detachably arranged to move along a movement axis in order to be, in an inserted position, functionally inserted entirely within the machine housing such that liquid can be delivered by use of the liquid pump from the liquid tank via the liquid circulation pipes and the liquid heater to the beverage brewing chamber for mixing the liquid with a beverage ingredient contained therein to prepare a beverage,
wherein the machine housing comprises a first opening and a second opening, which are located on opposite wall portions of the machine housing, and
wherein, when the liquid tank is in the inserted position, the first opening is arranged to expose a part of the liquid tank such that pushing said exposed part of the liquid tank moves the liquid tank along the movement axis and out of the inserted position trough said second opening.

2. The beverage preparation machine according to claim 1, wherein the wall portions are lateral wall portions.

3. The beverage preparation machine according to claim 1, wherein the movement axis extends parallel or oblique to the horizontal, when the beverage preparation machine is arranged to prepare a beverage.

4. The beverage preparation machine according to claim 1, wherein the liquid tank does not protrude from the machine housing, when the liquid tank is in the inserted position, and/or wherein the liquid tank comprises one or more lateral ends, wherein at least one of the one or more lateral ends is at least in part flush with the machine housing, such as with one of the wall portions or with the wall portions, respectively, when the liquid tank is in the inserted position.

5. The beverage preparation machine according to claim 1, wherein the machine housing comprises a front and a back, and wherein the liquid tank is arranged to be inclined towards the back, when the liquid tank is in the inserted position.

6. The beverage preparation machine according to claim 1, wherein the machine housing comprises a channel that is arranged at least partially inside of the machine housing to receive the liquid tank.

7. The beverage preparation machine according to claim 1, further comprising a first connector arranged at least partially in the machine housing and a second connector arranged at least partially on the liquid tank, wherein, in the inserted position of the liquid tank, the first connector and the second connector are connected to one another for delivering liquid from the liquid tank, wherein the first connector comprises a distal end with a connection opening, wherein the first connector is arranged such that the connection opening opens in a direction, which is parallel to the movement axis.

8. The beverage preparation machine according to claim 7, wherein the first connector and/or the second connector comprises one or more sealing elements, such as one or more radial sealing elements, wherein the one or more sealing elements are arranged to cooperate with the respective other connector for tightly connecting the connectors with one another, when the liquid tank is in the inserted position.

9. The beverage preparation machine according to claim 7, wherein the second connector comprises a valve adapted to move between a closed position and an open position, wherein the first connector is arranged to move the valve into the open position, when the liquid tank is moved into the inserted position, in order to connect the first connector with the second connector for delivering liquid from the liquid tank.

10. The beverage preparation machine according to claim 7, wherein the second connector comprises a socket for receiving at least part of the first connector, wherein the one or more sealing elements are arranged on the socket, and/or wherein a seal seat, on which the valve sits when the valve is in the closed position, is arranged on the socket.

11. The beverage preparation machine according to claim 10, wherein the socket comprises a socket opening, through which the at least part of the first connector can enter the socket for being received in the socket, wherein the seal seat is further distanced from the socket opening than the one or more sealing elements.

12. The beverage preparation machine according to claim 1, wherein the liquid tank comprises a transparent part and an opaque part, wherein, when the liquid tank is in the inserted position and when viewed at least along the movement axis, the opaque part is arranged to obstruct a view onto one or more parts arranged inside of the machine housing, such as onto the first connector and/or the second connector.

13. The beverage preparation machine according to claim 1, wherein the machine functional elements are arranged in the machine housing.

14. The beverage preparation machine according to claim 1, wherein at least part of the machine functional elements span a space, and wherein the liquid tank is at least partially arranged inside of the space, when the liquid tank is in the inserted position.

15. The beverage preparation machine according to claim 1, wherein the machine functional elements comprise one or more of the following: a brewing chamber, a brewing unit, a liquid heater, a control unit, a liquid pump, a capsule holder, one or more liquid circulation pipes, electronics, and combinations thereof.
